(19) United States
(12) Patent Application Publication
(10) Pub. No.: US 2008/0162544 A1
(43) Pub. Date: Jul. 3, 2008

(54) SYSTEMS AND METHODS FOR IMPLEMENTING MANY OBJECT TO OBJECT RELATIONSHIPS IN A MULTI-TENANT ENVIRONMENT

(75) Inventors: Craig Weissman, San Francisco, CA (US); Simon Wong, San Carlos, CA (US); Steven Tamm, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Salesforce.com, Inc., San Francisco, CA (US)

(21) Appl. No.: 11/616,744

(22) Filed: Dec. 27, 2006

(51) Int. Cl. G06F 7/00

(52) U.S. Cl. 707/103 R; 707/E17.055

(57) ABSTRACT

Systems and methods for storing relationship information for an information object in a database system. Methods and mechanisms for storing relationship information for information objects enable database systems to store and retrieve data objects having an arbitrary number of relationships with one another. This ability to store and retrieve data objects by relationship(s) enables more efficient searching of database objects and removal of constraints on the number of relationships that would otherwise exist when objects are stored in a database.

### CROSS REFERENCE TO RELATED APPLICATIONS

This application is related to U.S. patent application Ser. No. 10/817,161 entitled “Custom Entities and Fields in a Multi-Tenant Database System” by Simon Wong et al., filed Apr. 2, 2004, Attorney Docket No. 021735-000500US, which is incorporated by reference herein in its entirety.

### FIELD OF THE INVENTION

The present invention relates generally to database systems, and more particularly to systems and methods for implementing many object to object relationships in a multi-tenant on-demand database service.

### BACKGROUND

In conventional database systems, users access their data resources in one logical database. A user of such a conventional database system typically retrieves data from and stores data on the database system using the user's own systems. A user system might remotely access one of a plurality of server systems that might in turn access the database system. Data retrieval from the system might include the issuance of a query from the user system to the database system. The database system might process the request for information received in the query and send to the user system information relevant to the request. Object oriented databases store information objects in the form of tables, comprised of rows and columns, in the database.

Unfortunately, not all data objects are easily represented in conventional database tables. In some cases, users may wish to store one or more relationships between one or more fields in data objects and search upon these relationships. These relationships, however, impart a multi-dimensional characteristic to the data, making storage in the conventional row-column format of conventional databases unwieldy.

Conventional approaches suffer from the drawbacks that they force an arbitrary limit on the number of relationships per entity based on decisions made when the database tables are defined.

Therefore it is desirable to provide systems and methods that overcome the above and other problems.

### BRIEF SUMMARY

The present invention provides systems and methods for storing relationship information for an information object in a database system. Methods and mechanisms for storing relationship information for information objects enable database systems to store and retrieve data objects having an arbitrary number of relationships with one another. This ability to store and retrieve data objects by relationship(s) enables more efficient searching of database objects and removal of constraints on the number of relationships that would otherwise exist when objects are stored in a database. Embodiments of the present invention may provide one or more of increased number of relationships, improve performance, and allow relationships to be applied to any object in the system.

According to one embodiment, and by way of example, a method for storing relationship information for an information object in a database system is provided. This method embodiment includes receiving an information object to store in a portion of a database accessible to a tenant of a plurality of tenants having access to a plurality of other portions of the database. The plurality of portions comprises a single table of the database (“main table”). The information object relates to at least one other information object by relationship information identifying the other information object in the database. The relationship information is stored to an index table (“index table”), enabling locating information objects related to the information object received without searching the main table once the information object is stored in the main table.

According to another embodiment, a machine-readable medium is provided that stores or carries one or more sequences of instructions for storing relationship information for an information object in a database system, which instructions, when executed by one or more processors, cause the one or more processors to carry out the step of receiving an information object to store in a portion of a database accessible to a tenant of a plurality of tenants having access to a plurality of other portions of the database, the plurality of portions comprising a single table of the database (“main table”), the information object relating to at least one other information object by relationship information identifying the other information object in the database, and the step of storing the relationship information to an index table (“index table”) enabling locating information objects related to the information object received without searching the main table, once the information object is stored in the main table.

According to another embodiment, an apparatus is provided for storing relationship information for an information object in a database system. The apparatus typically includes a processor, and one or more stored sequences of instructions which, when executed by the processor, cause the processor to carry out the step of receiving an information object to store in a portion of a database accessible to a tenant of a plurality of tenants having access to a plurality of other portions of the database, the plurality of portions comprising a single table of the database (“main table”), the information object relating to at least one other information object by relationship information identifying the other information object in the database, and the step of storing the relationship information to an index table (“index table”) enabling locating information objects related to the information object received without searching the main table, once the information object is stored in the main table.

According to yet another embodiment, a method is provided for transmitting code for storing relationship information for an information object in a database system on a transmission medium. The method typically includes transmitting code for receiving an information object to store in a portion of a database accessible to a tenant of a plurality of tenants having access to a plurality of other portions of the database, the plurality of portions comprising a single table of the database (“main table”), the information object relating to at least one other information object by relationship information identifying the other information object in the database, and transmitting code for storing the relationship information to an index table (“index table”) enabling locating information objects related to the information object received without searching the main table, once the information object is stored in the main table.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

FIG. 1 illustrates an environment wherein an on-demand database service might be used.

FIG. 2 illustrates elements of an example system and various interconnections in an embodiment.

FIGS. 3A-3C illustrate data diagrams of database fields and relationships supporting techniques for storing relationship information for information objects in embodiments.

FIG. 4 illustrates an operational flow diagram illustrating a high level overview of a technique for storing relationship information for an information object in an embodiment.

### DETAILED DESCRIPTION

The present invention provides systems and methods for implementing many object to object relationships in a database system. In one aspect, the methods and mechanisms described herein are implemented in the context of a multi-tenant on-demand database service to provide many object to object relationship management to users of such a service, however such multi-tenant, on-demand architecture is not necessary to practice the claimed embodiments.

As used herein, the term multi-tenant database system refers to those systems in which various elements of hardware and software of the database system may be shared by one or more organizations (or “tenants”). For example, a given application server may simultaneously process requests for a great number of organizations, and a given database table may store rows for a potentially much greater number of organizations.

In embodiments, there is provided a mechanism of extension called “Custom Objects” where an organization can custom design an entity object, its associated fields, and relationships to other objects. These relationships are typically stored separately from regular fields and may be limited in number, e.g., 5 relationship fields. Embodiments store these relationships separately in the “main” table of the database in order to index these relationships in the database to support traversing the relationship for displaying related lists and so forth. By storing only links from child objects to parent objects, an index on the column is required to display all the child objects related with a parent object. In addition, this field stores an empty key to signify an empty relationship in the database instead of null.

In one embodiment, relationships are treated like any other custom field. For example, for a relationship, the ID is stored in the field directly, and if the relationship is empty, a NULL is stored in the database. Also, relationships are allowed to be added to any entity with custom fields. In one embodiment, relationships are indexed in a separate “index” table. For example, only the non-null entries are stored, and both the source and target of a relationship are indexed. Such separate index table enables embodiments to provide more efficient traversal of objects based upon relationships, and using multi-way searching, such as for example and without limitation, a search based upon source object, i.e., locate all objects this one points to, or a search based upon target object, i.e., locate all objects pointing to this object. Other search strategies are also contemplated by other embodiments.

Embodiments can provide an arbitrarily large number of custom objects, with each object being indexed. In addition, relationships can be applied to any object in the system that has custom fields without requiring changes to the data model associated with those objects.

Next, mechanisms and methods for providing object relationships will be described with reference to example embodiments.

### System Overview

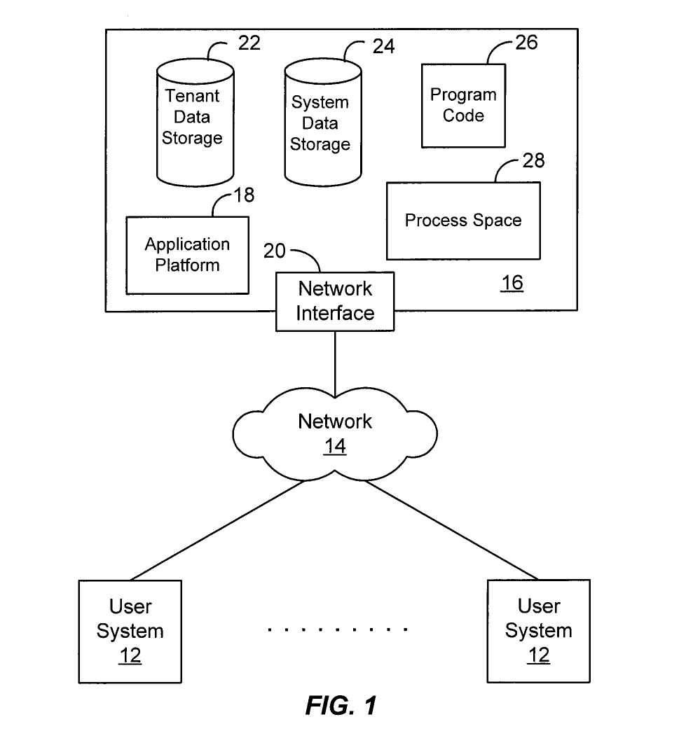

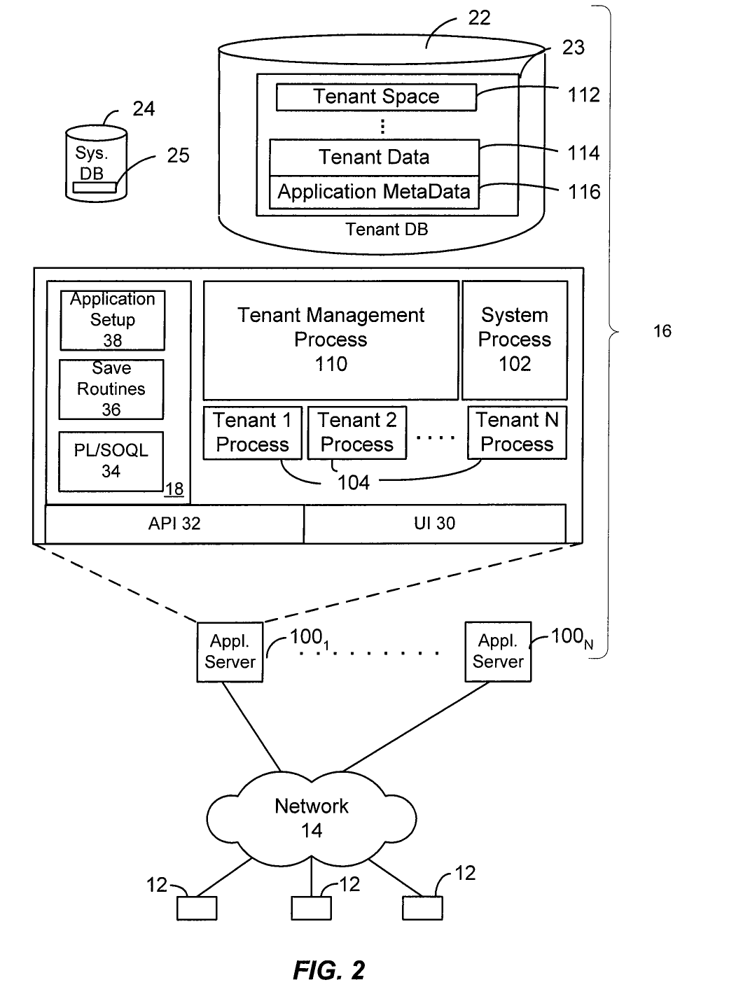

FIG. 1 illustrates an environment wherein an on-demand database service might be used. As illustrated in FIG. 1 (and in more detail in FIG. 2) user systems 12 might interact via a network 14 with an on-demand database service 16. Some on-demand database services may store information from one or more tenants stored into tables of a common database image to form a multi-tenant database system (MTS). Accordingly, on-demand database service 16 and system 16 will be used interchangeably herein. A database image may include one or more database objects. A relational database management system (RDMS) or the equivalent may execute storage and retrieval of information against the database object(s). Some on-demand database services may include an application platform 18 that enables creation, managing and executing one or more applications developed by the provider of the on-demand database service, users accessing the on-demand database service via user systems 12, or third party application developers accessing the on-demand database service via user systems 12.

The users of those user systems 12 might be users in differing capacities, and the capacity of a particular user system 12 might be entirely determined by permissions (permission levels) for the current user. For example, where a salesperson is using a particular user system 12 to interact with System 16, that user system has the capacities allotted to that salesperson. However, while an administrator is using that user system to interact with System 16, that user system has the capacities allotted to that administrator. In systems with an hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 14 can be a LAN (local area network), WAN (wide area network), wireless network, point-to-point network, star network, token ring network, hub network, or other appropriate configuration. As the most common type of network in current use is a TCP/IP (Transfer Control Protocol and Internet Protocol) network such as the global internetwork of networks often referred to as the “Internet” with a capital “I,” that will be used in many of the examples herein. However, it should be understood that the networks that the present invention might use are not so limited, although TCP/IP is a frequently implemented protocol.

User systems 12 might communicate with System 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP messages to and from an HTTP server at System 16. Such HTTP server might be implemented as the sole network interface between System 16 and network 14, but other techniques might be used as well or instead. In some implementations, the interface between System 16 and network 14 includes load sharing functionality, such as round-robin HTTP request distributors to balance loads and distribute incoming HTTP requests evenly over a plurality of servers. At least as for the users that are accessing that server, each of the plurality of servers has access to the MTS′ data; however, other alternative configurations are contemplated.

In one embodiment, the system shown in FIG. 1 implements a web-based customer relationship management (CRM) system. For example, in one embodiment, System 16 includes application servers configured to implement and execute CRM software applications as well as provide related data, code, forms, Web pages and other information to and from user systems 12 and to store to, and retrieve from, a database system related data, objects and Web page content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of System 16 is shown in FIG. 1, including a network interface 20, application platform 18, storage 22 for tenant data, storage 24 for system data accessible to System 16 and possibly multiple tenants, program code 26 for implementing various functions of System 16, and a process space 28 for executing MTS system processes and tenant-specific processes, such as running applications as part of an application hosting service. Additional processes that may execute on System 16 include database indexing processes.

Several elements in the system shown in FIG. 1 include conventional, well-known elements that need not be explained in detail here. For example, each user system 12 could include a desktop personal computer, workstation, laptop, PDA, cell phone, or any wireless access protocol (WAP) enabled device or any other computing device capable of interfacing directly or indirectly to the Internet or other network connection. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from System 16 over network 14. Each user system 12 also typically includes one or more user interface devices, such as a keyboard, a mouse, touch screen, pen or the like, for interacting with a graphical user interface (GUI) provided by the browser on a display (e.g., monitor screen, LCD display, etc.) in conjunction with pages, forms, applications and other information provided by System 16 or other systems or servers. For example, the user interface device can be used to access data and applications hosted by System 16, and to perform searches on stored data, and otherwise allow a user to interact with various GUI pages that may be presented to a user.

As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 12 and all of its components are operator configurable using applications, such as a browser, including computer code run using a central processing unit such as an Intel Pentium® processor or the like. Similarly, System 16 (and additional instances of an MTS, where more than one is present) and all of their components might be operator configurable using application(s) including computer code run using a central processing unit such as an Intel Pentium® processor or the like, or multiple processor units. A computer program product embodiment includes a machine-readable storage medium (media) having instructions stored thereon/in which can be used to program a computer to perform any of the processes of the embodiments described herein. Computer code for operating and configuring System 16 to intercommunicate and to process web pages, applications and other data and media content as described herein is preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments of the present invention can be implemented in any programming language that can be executed on a client system and/or server or server system such as, for example, in C, C++, HTML, any other markup language, Java™, JavaScript, ActiveX, any other scripting language such as VBScript, and many other programming languages as are well known. (Java™ is a trademark of Sun Microsystems, Inc.).

According to one embodiment, each System 16 is configured to provide web pages, forms, applications, data and media content to user (client) systems 12 to support the access by user systems 12 as tenants of System 16. As such, System 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 2 illustrates elements of an example System 16 and various interconnections in an embodiment. As shown by FIG. 2, example System 16 includes a network interface 20 (of FIG. 1) implemented as one or more HTTP application servers 100, an application platform 18 and database objects 106, 108. Also shown is system process space 102, including individual tenant process spaces 104, a tenant management process space 110 and database objects 106, 108. A Tenant database 108 might be divided into individual tenant storage areas 112, which can be either a physical arrangement or a logical arrangement. Within each tenant storage area 112, user storage 114 and application storage 116 might similarly be allocated for each user. For example, a copy of a user's most recently used (MRU) items might be stored to user storage area 114. Similarly, a copy of MRU items for an entire organization that is a tenant might be stored to tenant storage area 112. A user interface UI 30 provides a user interface and an API 32 provides an application programmer interface to System 16 resident processes to users and/or developers at user systems 12.

Application platform 18 includes an application setup mechanism 38 that supports application developers' creation and management of applications, which may be saved as metadata into tenant database 108 by save routines 36 for execution by subscribers as one or more tenant processes 104 managed by tenant management process 110 for example. Invocations to such applications may be coded using PL/SOQL 34 that provides a programming language style interface extension to API 32. Invocations to applications may be detected by one or more system processes, which manage retrieving application metadata 116 for the subscriber making the invocation and executing the metadata as an application in a virtual machine.

It should also be understood that each application server 100 may be communicably coupled to database systems, e.g., system database 106 and tenant database(s) 108, via a different network connection. For example, one server 1001 might be coupled via the Internet 14, another server 100N−1 might be coupled via a direct network link, and another server 100N might be coupled by yet a different network connection. Transfer Control Protocol and Internet Protocol (TCP/IP) are typical protocols for communicating between servers 100 and the database system; however, it will be apparent to one skilled in the art that other transport protocols may be used to optimize the system depending on the network interconnect used.

In certain embodiments, each application server 100 is configured to handle requests for any user associated with any organization that is a tenant. Because it is desirable to be able to add and remove application servers from the server pool at any time for any reason, there is preferably no server affinity for a user and/or organization to a specific application server 100. In one embodiment, therefore, an interface system implementing a load balancing function (e.g., an F5 Big-IP load balancer) is communicably coupled between the servers 100 and the user systems 12 to distribute requests to the servers 100. In one embodiment, the load balancer uses a least connections algorithm to route user requests to the servers 100. Other examples of load balancing algorithms, such as round robin and observed response time, also can be used. For example, in certain embodiments, three consecutive requests from the same user could hit three different servers 100, and three requests from different users could hit the same server 100. In this manner, System 16 is multi-tenant, wherein System 16 handles storage of, and access to, different objects, data and applications across disparate users and organizations.

As an example of storage, one tenant might be a company that employs a sales force where each salesperson uses System 16 to manage their sales process. Thus, a user might maintain contact data, leads data, customer follow-up data, performance data, goals and progress data, etc., all applicable to that user's personal sales process (e.g., in tenant database 108). In an example MTS arrangement, since all of this data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by System 16 that are allocated at the tenant level while other data structures might be managed at the user level. Because an MTS might support multiple tenants including possible competitors, the MTS should have security protocols that keep data, applications, and application use separate. Also, because many tenants will opt for access to an MTS rather than maintain their own system, redundancy, up-time, and backup are additional critical functions and need to be implemented in the MTS.

In addition to user-specific data and tenant-specific data, System 16 might also maintain system level data usable by multiple tenants or other data. Such system level data might include industry reports, news, postings, and the like that are sharable among tenants.

In certain embodiments, client systems 12 communicate with application servers 100 to request and update system-level and tenant-level data from System 16 that may require one or more queries to database system 106 and/or database system 108. System 16 (e.g., an application server 100 in System 16) automatically generates one or more SQL statements (the SQL query) designed to access the desired information. Database system 108 may generate query plans to access the requested data from the database.

Each database can generally be viewed as a collection of objects, such as a set of logical tables, containing data fitted into predefined categories. A “table” is one representation of a data object, and is used herein to simplify the conceptual description of objects and custom objects according to the present invention. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead and Opportunity data, each containing pre-defined fields. It should be understood that “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

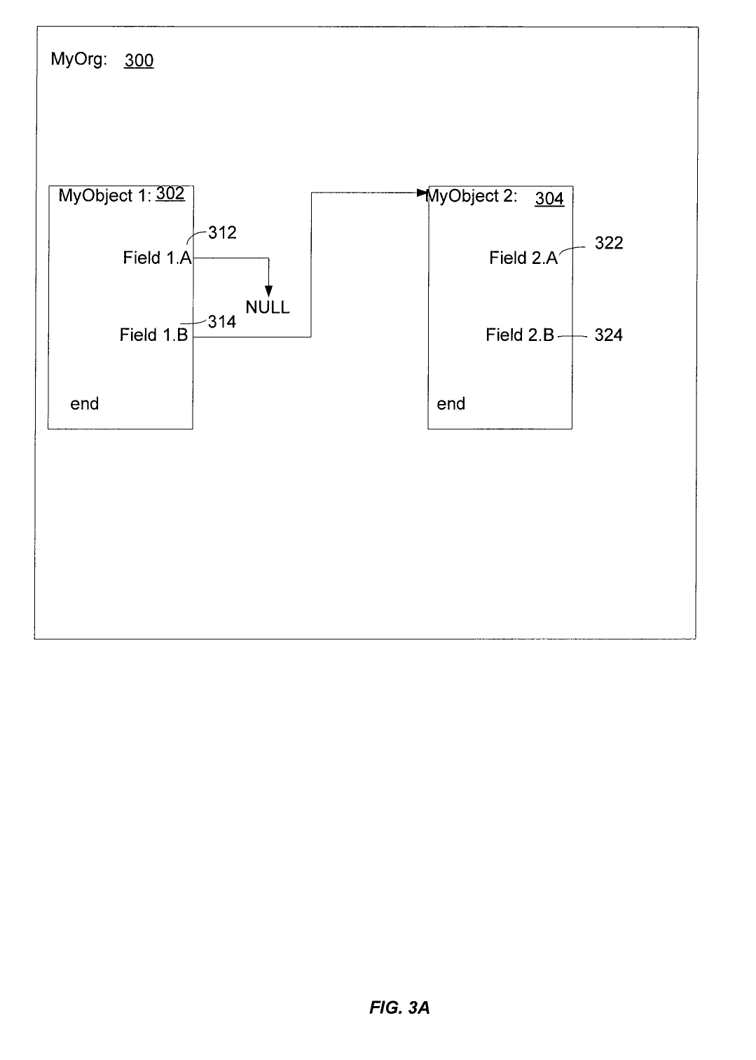

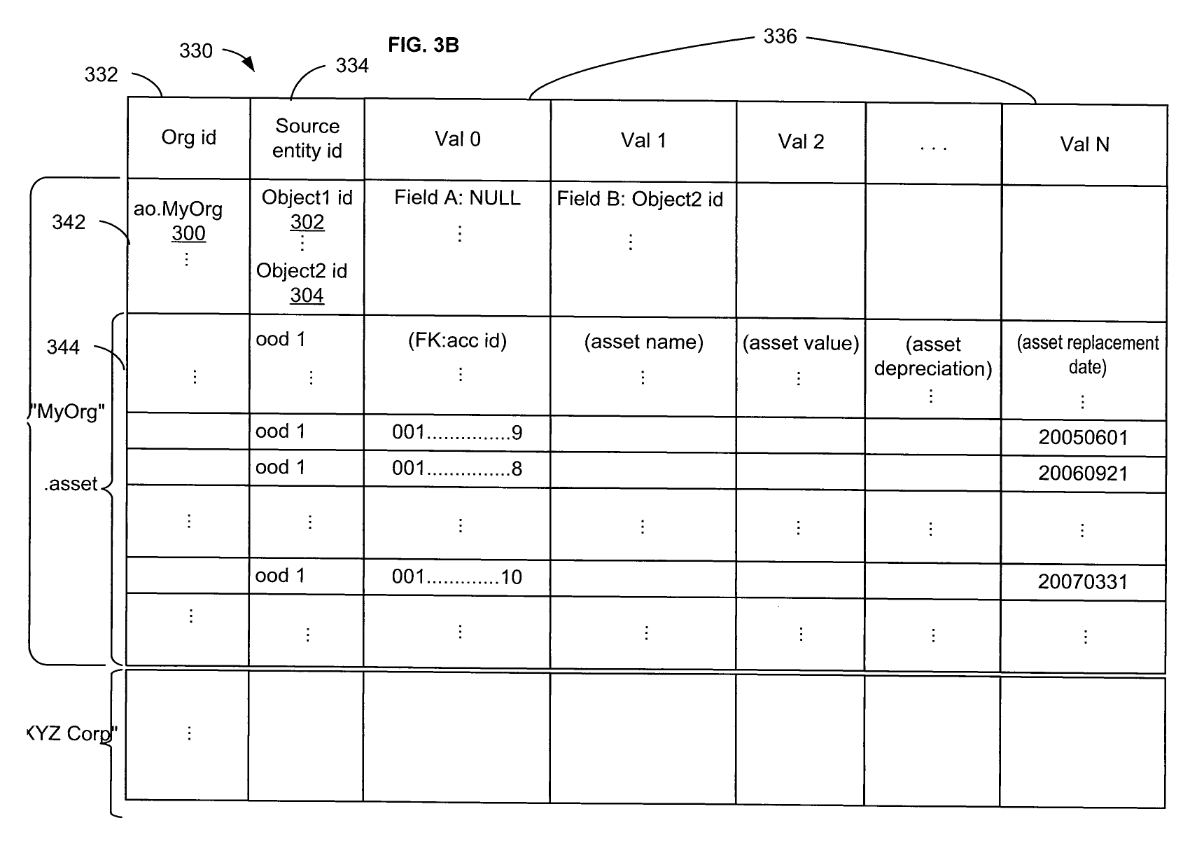

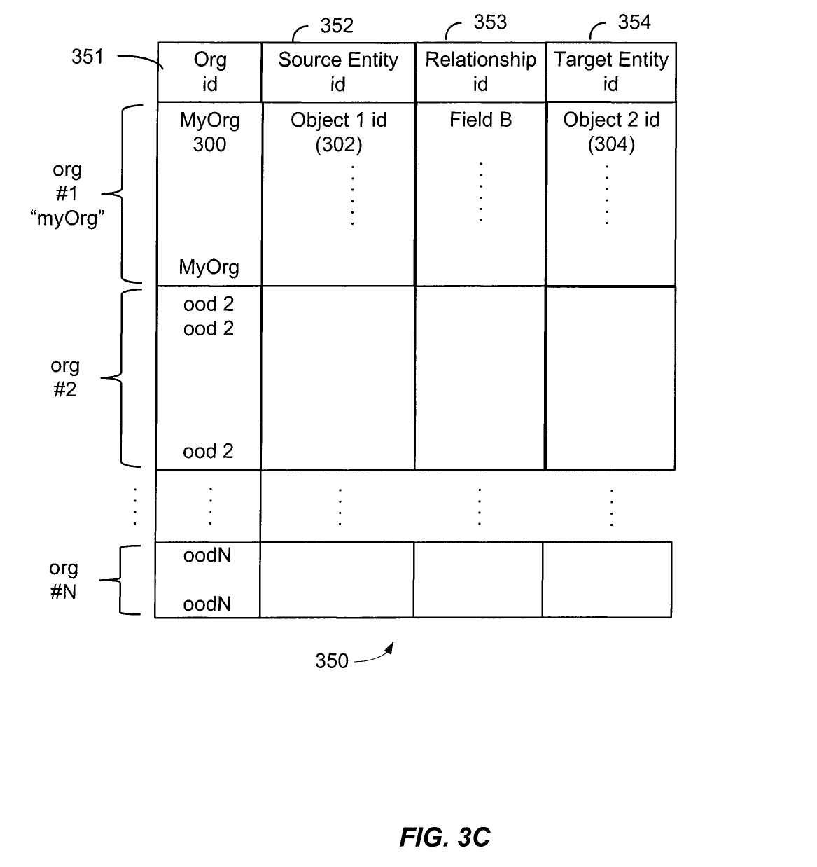

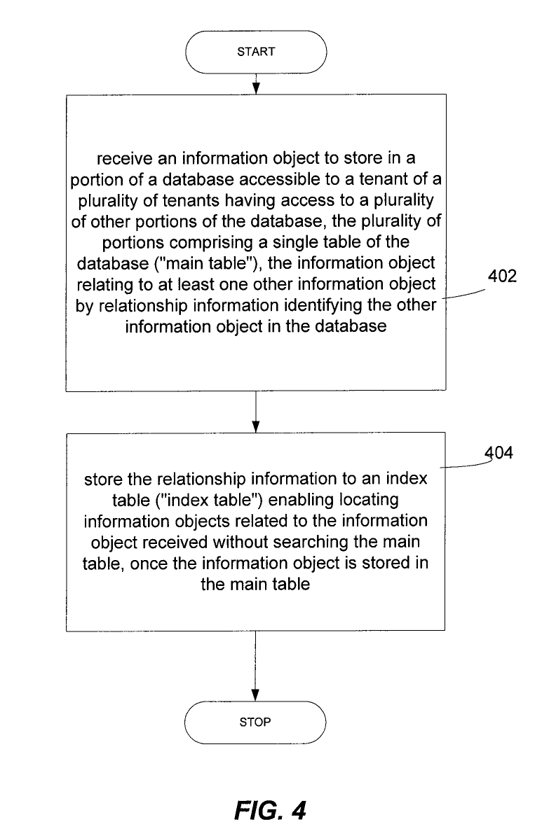

FIGS. 3A-3C illustrate data diagrams of database fields and relationships and FIG. 4 illustrates an operational flow diagram illustrating a high level overview of a technique for storing relationship information for an information object in an embodiment. In one embodiment, the methods and mechanisms for storing relationship information for an information object mechanism as shown in FIGS. 3A-4 are implemented in the multi-tenant database system 16 of FIG. 1.

As show in FIG. 3A, in an embodiment, one or more information objects 302, 304 are received (step 402 of FIG. 4) for storage. Information objects 302, 304 belong to a particular tenant, “MyOrg” 300 in this example. The information object 302 relates to at least one other information object 304 by relationship information stored in custom field 314 identifying the other information object 304. Some custom fields 312 may indicate no relationship using a NULL. Further, the other information object 304 may include custom fields 322, 324 and may itself include relationships to still further objects not shown in FIG. 3A. The information object 302 will be stored in a portion of a database accessible to a tenant of a plurality of tenants having access to a plurality of other portions of the database. The plurality of portions comprises a single table of the database (“main table”). In one aspect, the relationship(s) between information objects is stored in a second table, called the “index” table as will be described with reference to FIG. 3B.

As shown by FIG. 3B, in an embodiment and by way of example, storage of custom fields 336 of custom objects 342, i.e., user defined data objects, (or of pre-defined “standard” objects 344) includes a set of database columns, which may be allocated on a per-organization basis using an org_id 332 in multi-tenant arrangements, but which are stored in the same “main” table 330 of the database. Custom fields 336 can store any data type and are not indexed. Rather, in one embodiment, the data in the field is copied to a separate “index” table 350 of FIG. 3C to support using an index for reporting purposes. These custom fields are available to the major entities in the database service.

MyOrg's org id column 332 of the main table 330 includes entries for custom objects 342 having source entity ids Object 1 id (302) and Object 2 id (304) in the source entity id column 334. A first custom field 336, Val 0, includes an entry “Field A: NULL”, indicating field 312 of object 302 is a NULL. A second custom field 336, Val 1, includes an entry “Field B: Object 2 id”, corresponding to the relationship to myObject 2 304 of FIG. 3A.

Indexes may be used to represent the existence of such relationships. By way of example and without limitation, operations that display related lists typically involve traversing relationships, both custom and standard. Since displaying such related lists is one of the more frequently requested functions, it is highly desirable to quickly obtain a list of objects that are the source of a relationship to the current object. In an embodiment, to maintain relationship information for efficient traversal, an index based on the source entity 334 is maintained. Thus according to one embodiment, relationship data is stored (step 404 of FIG. 4) in an “index” table when a record is stored to a “main” table/entity 330 as will be described with reference to FIG. 3C.

FIG. 3C illustrates an example of an index table according to one embodiment. As shown in FIG. 3C, in an embodiment and by way of example, functionally, an index table 350 includes the following information:
Organization Id 351
Source Entity Id 352
Relationship Id 353
Target Entity Id 354

Example relationship information between information object 1 302 and object 2 304 is entered into table 350 by storing a source entity id 352 for object 1 id (302), a target entity id 354 for object 2 id (304) and a relationship id 353 of field B in the example illustrated by FIG. 3C.

In this way, table 350 is uniquely indexed based on (i) the organization id, relationship id and source entity id, and also by (ii) organization id, relationship id, and target entity id. This “multi-way” indexing allows for traversing of multiple relationships in either direction using the same index table 350, regardless of the original main table 300. This enables determining which entities are pointed to, and also which entities point to an entity. In this manner, hierarchical stability is also maintained.

By storing the target entity id both with the set of custom fields 336 and also in the index table 350, relationships are able to be applied to standard objects as well. This allows relationships to have children that include standard objects, not just custom objects.

The following Table 1 shows object-to-object relationship functionality provided by various embodiments:

In certain embodiments, indexed relationship data provides for query optimization. When reporting on a relationship, for example, the query optimizer now has a choice to make. If the query should drive from the source of the relationship towards the destination, the query will use the custom field that contains the relationship link. If the query should drive from the destination, the query will join to the relationship index table and follow it to the source objects. In other embodiments, the query may perform a table scan.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method of storing relationship information for an information object in a database system, comprising:
receiving an information object to store in a portion of a database accessible to a tenant of a plurality of tenants having access to a plurality of other portions of the database, the plurality of portions comprising a single table of the database (“main table”), the information object relating to at least one other information object by relationship information identifying the other information object in the database; and
storing the relationship information to an index table (“index table”) enabling locating information objects related to the information object received without searching the main table, once the information object is stored in the main table.

2. The method of claim 1, wherein receiving an information object to store in a portion of a database accessible to a tenant of a plurality of tenants having access to a plurality of other portions of the database includes:
receiving a user defined (custom) object having at least one relationship to at least one other object, the at least one other object comprising at least one of another custom object and a predefined (standard) object.

3. The method of claim 1, wherein receiving an information object to store in a portion of a database accessible to a tenant of a plurality of tenants having access to a plurality of other portions of the database includes:
receiving a pre-defined (standard) object having at least one relationship to at least one other object indicated by at least one user defined (custom) field, the at least one other object comprising at least one of a user defined (custom) object and another predefined (standard) object.

4. The method of claim 1, wherein storing the relationship information to an index table includes:
storing relationship information in a multi-way uniquely indexed table.

5. The method of claim 4, wherein storing relationship information in a multi-way uniquely indexed table includes:
storing multiple indexes enabling traversing of multiple relationships in either a source entity to target entity direction or a target entity to source entity direction using the same index table.

6. The method of claim 5, wherein storing multiple indexes enabling traversing of multiple relationships in either a source entity to target entity direction or a target entity to source entity direction using the same index table includes:
storing relationship information in the index table based on the organization id, relationship id and source entity id, and also by organization id, relationship id, and target entity id.

7. The method of claim 4, wherein storing relationship information in a multi-way uniquely indexed table includes:
storing multiple indexes enabling traversing of multiple relationships in either a source entity to target entity direction or a target entity to source entity direction regardless of the original source table.

8. The method of claim 1, wherein storing the relationship information to an index table includes:
storing a target entity id with a set of custom fields in the main table and in the index table.

9. The method of claim 8, wherein storing a target entity id with a set of custom fields in the main table and in the index table enables:
applying relationships to standard objects.

10. A machine-readable medium carrying one or more sequences of instructions for storing relationship information for an information object in a database system, which instructions, when executed by one or more processors, cause the one or more processors to carry out the steps of:
receiving an information object to store in a portion of a database accessible to a tenant of a plurality of tenants having access to a plurality of other portions of the database, the plurality of portions comprising a single table of the database (“main table”), the information object relating to at least one other information object by relationship information identifying the other information object in the database; and
storing the relationship information to an index table (“index table”) enabling locating information objects related to the information object received without searching the main table, once the information object is stored in the main table.

11. The machine-readable medium as recited in claim 10, wherein the instructions for carrying out the step of receiving an information object to store in a portion of a database accessible to a tenant of a plurality of tenants having access to a plurality of other portions of the database include instructions for carrying out the step of:
receiving a user defined (custom) object having at least one relationship to at least one other object, the at least one other object comprising at least one of another custom object and a predefined (standard) object.

12. The machine-readable medium as recited in claim 10, wherein the instructions for carrying out the step of receiving an information object to store in a portion of a database accessible to a tenant of a plurality of tenants having access to a plurality of other portions of the database include instructions for carrying out the step of:
receiving a pre-defined (standard) object having at least one relationship to at least one other object indicated by at least one user defined (custom) field, the at least one other object comprising at least one of a user defined (custom) object and another predefined (standard) object.

13. The machine-readable medium as recited in claim 10, wherein the instructions for carrying out the step of storing the relationship information to an index table include instructions for carrying out the step of:
storing relationship information in a multi-way uniquely indexed table.

14. The machine-readable medium as recited in claim 13, wherein the instructions for carrying out the step of storing relationship information in a multi-way uniquely indexed table include instructions for carrying out the step of:
storing multiple indexes enabling traversing of multiple relationships in either a source entity to target entity direction or a target entity to source entity direction using the same index table.

15. The machine-readable medium as recited in claim 14, wherein the instructions for carrying out the step of storing multiple indexes enabling traversing of multiple relationships in either a source entity to target entity direction or a target entity to source entity direction using the same index table include instructions for carrying out the step of:
storing relationship information in the index table based on the organization id, relationship id and source entity id, and also by organization id, relationship id, and target entity id.

16. The machine-readable medium as recited in claim 13, wherein the instructions for carrying out the step of storing relationship information in a multi-way uniquely indexed table include instructions for carrying out the step of:
storing multiple indexes enabling traversing of multiple relationships in either a source entity to target entity direction or a target entity to source entity direction regardless of the original source table.

17. The machine-readable medium as recited in claim 10, wherein the instructions for carrying out the step of storing the relationship information to an index table include instructions for carrying out the step of:
storing a target entity id with a set of custom fields in the main table and in the index table.

18. The machine-readable medium as recited in claim 17, wherein the instructions for carrying out the step of storing a target entity id with a set of custom fields in the main table and in the index table include instructions for carrying out the step of:
applying relationships to standard objects

19. An apparatus for storing relationship information for an information object in a database system, the apparatus comprising:
a processor; and
one or more stored sequences of instructions which, when executed by the processor, cause the processor to carry out the steps of:
receiving an information object to store in a portion of a database accessible to a tenant of a plurality of tenants having access to a plurality of other portions of the database, the plurality of portions comprising a single table of the database (“main table”), the information object relating to at least one other information object by relationship information identifying the other information object in the database; and
storing the relationship information to an index table (“index table”) enabling locating information objects related to the information object received without searching the main table, once the information object is stored in the main table.

20. A method for transmitting code for storing relationship information for an information object in a database system on a transmission medium, the method comprising:
transmitting code for receiving an information object to store in a portion of a database accessible to a tenant of a plurality of tenants having access to a plurality of other portions of the database, the plurality of portions comprising a single table of the database (“main table”), the information object relating to at least one other information object by relationship information identifying the other information object in the database; and
transmitting code for storing the relationship information to an index table (“index table”) enabling locating information objects related to the information object received without searching the main table, once the information object is stored in the main table.
